(19) United States
(12) Patent Application Publication
(10) Pub. No.: US 2022/0087786 A1
(43) Pub. Date: Mar. 24, 2022

(54) OCCLUSAL SCREW, DENTAL IMPLANT SYSTEM AND SET

(71) Applicant: Z-Systems AG, Oensingen (CH)

(72) Inventors: Ernst Thomke, Grenchen (CH); Claude Theubet, Laupersdorf (CH)

(21) Appl. No.: 17/424,618

(22) PCT Filed: Jan. 21, 2020
(86) PCT No.: PCT/EP2020/051359

§ 371 Date: Jul. 21, 2021

(30) Foreign Application Priority Data
Jan. 22, 2019 (CH) 00071/19

(51) Int. Cl. A61C 8/00

(52) U.S. Cl. CPC A61C 8/0068; A61C 8/0012; A61C 8/0069; A61C 8/0089; A61C 8/0022

(57) ABSTRACT

An occlusal screw for a two-part dental implant system with an anchoring part and an abutment includes a screw head and a screw shank. The screw head apically forms a screw stop. The occlusal screw consists of a ceramic material and has an engagement portion with an outer structure that is not rotationally symmetrical about the screw axis, is cylindrical or conical at least in regions and is suitable for interacting with a corresponding inner structure in a distal recess of a screwing tool, in order to couple the occlusal screw onto the screwing tool in a rotationally fixed manner. A design concerning which the engagement portion occlusally includes a cylindrical region and apically thereof a clamping region, which continuously widens in the apical direction, is particularly advantageous. The clamping region can be for example conical.

### BACKGROUND OF THE INVENTION

### Field of the Invention

The invention relates to the field of medical technology. It relates to an occlusal screw, a ceramic dental implant system as well as to a set.

### Description of Related Art

Amongst dental implant systems, two-part implant systems are widespread. These comprise the actual implant (also called “anchoring part” or, if it is provided with a thread, “screw”) and an attachment part (“abutment”) which is provided for fastening thereto. The anchoring part can herein be designed such that it is incorporated roughly level with the bone surface (as a so-called bone-level implant), or it can be provided with a region coronally of the bone surface, said region often being widened with respect to the enossal region that is generally provided with a thread, sometimes being denoted as a tulip and being provided for reaching roughly to the gum surface. Implants with such a transgingival region are called tissue level implants. The region (“post”) which projects out of the gums and which serves for fastening a superstructure, thus a crown, bridge or prosthesis or the like is formed by the abutment with two-part implant systems.

Apart from the tried and tested titanium, ceramic materials are of increasing importance, amongst these in particular zirconium oxide ceramics (also denoted as “zircon” which is not entirely scientifically correct). Ceramic implants on account of their colour have aesthetic advantages; furthermore they favour the integration of bone tissue and gingival tissue at the implant surface particularly well and are often met with a better acceptance by the patient than metallic implants. However, they have the disadvantage that they are brittle-hard and in contrast to the more ductile metallic implants tend to brittle fracture given a higher mechanical loading, which is also why not all implant shapes can be manufactured without further ado.

Concerning two-part implant systems, there are different possibilities for fastening the abutment to the anchoring part. A screw, which in this text is called an occlusal screw, is often used in titanium-based systems and is led through a recess in the abutment, the recess being accessible from the coronal side, and engages into a thread in the anchoring part. The head of the occlusal screw bears on a shoulder that is formed in the mentioned recess of the abutment and by way of this presses the abutment against the anchoring part and its fastening post into the recess of the anchoring part which is envisaged for this.

Inherent of its design, such an occlusal screw locally effects very high forces on certain structures of the anchoring part and of the abutment, which is why, although being quite widespread in titanium-based systems, it would however often lead to failure in the case of the brittle-hard ceramic systems. For this reason, ceramic systems are mostly bonded, i.e. the abutment is fastened to the anchoring part by way of an adhesive which entails the known disadvantages of bonding connections.

A two-part bone level implant system, which is based on ceramic, is known from WO 2017/096494, concerning which an occlusal screw is held with the help of an insert element that is mounted in the recess of the anchoring part.

Ceramic dental implant systems are also disclosed in the Swiss patent applications 00391/18 and 00391/18. The shapes of the respective occlusal screws however generally only permit the manufacture from metallic materials.

### SUMMARY OF THE INVENTION

It is an object of the present invention to provide a two-part implant system with an anchoring part and abutment as well as suitable components for such, which overcome the disadvantages of the state of the art, are met with a good acceptance by patients and furthermore are designed such that a failure during the fastening of the abutment to the anchoring part and subsequently in the implanted state is less probable.

According to an aspect of the invention, an occlusal screw for a two-part dental implant system with an anchoring part and an abutment is provided, the occlusal screw has a screw head and a screw shank, wherein the screw shank comprises a screw thread which defines a screw axis, and is envisaged to engage through an opening of the abutment which is continuous in the axial direction, into an inner thread in a recess of the anchoring part, and wherein the screw head apically forms a screw stop. The screw stop, in order to fix the abutment relative to the anchoring part, is designed for abutting on a corresponding shoulder of the opening of the abutment when the screw shank engages into the mentioned inner thread. The occlusal screw consists of a ceramic material and includes an engagement portion which has an outer structure which is not rotationally symmetrical about the screw axis, is cylindrical or conical at least in regions and is suitable for interacting with a corresponding inner structure in a distal recess of a screwing tool, in order to couple the occlusal screw onto the screwing tool in a rotationally fixed (“torque-proof”) manner.

The occlusal screw according to this approach therefore differs from conventional occlusal screws, which are generally manufactured based on titanium, by way of the fact that for interacting with the screwing tool, it has no inner structure but an outer structure, for example an outer hex, or an outer square, outer pentagon, outer heptagon, outer octagon or another suitable outer structure. Herein, the symmetry of the outer structure in particular is selected such that the screw can be brought into engagement with the screwing tool in several possible relative orientations. I.e., the outer structure in particular can be symmetrical with regard to rotations about a certain angle, for example 60° in the case of an outer hex.

An outer structure is to be understood as a structure of an outer surface that is different from the circularly cylindrical shape, in contrast to an inner structure that is present at an inner wall of an opening. In particular, the outer structure comprises a structure of the outer lateral surface and is thus not merely limited to the end-face.

In the context of ceramic as a screw material, the design of the screw head with an outer structure instead of an inner structure has been found to be advantageous. In particular, the screw head can be more solid compared to the state of the art and therefore be less prone to breakage on screwing in the occlusal screw.

The screwing tool includes an engagement region with the distal recess, corresponding to the engagement portion.

Even in the case of completely ceramic dental implant systems, tools of materials other than ceramic, which do not remain in the patient, are accepted without further ado. For this reason, the screwing tool at least in a distal region can be manufactured of a suitable hard but nevertheless ductile material, for example stainless steel. This permits the engagement region to be designed in a relatively thin-walled manner, which is advantageous considering the restricted diameter of the continuous opening in the abutment and the desire for a solid as possible screw head. In other words, the procedure according to the invention permits the material strength of the occlusal screw, specifically of its head, to be optimised, which is particularly favourable in the context of ceramic material.

In embodiments, the screw head apically of the engagement portion forms a widening. An outer diameter in the region of the widening can correspond roughly to the outer diameter of the engagement region of the screwing tool. Thus, the screwing tool can be flush with the widest region of the screw head.

A design concerning which the engagement portion occlusally includes a cylindrical region (in this text “cylindrical” is generally not only used for circularly cylindrical shapes, but in the context of the general mathematical cylinder for surfaces which are translationally symmetrical along a part-stretch of an axis, in particular the screw axis) and apically of this a clamping region which widens apically in a continuous manner, is particularly advantageous. The clamping region can for example be conical. The fact that the clamping region continuously widens means that at least regionally no shoulder, which is perpendicular to the screw axis, is formed in the peripheral direction, but a tangent to the outer surface in the clamping region is at an angle to the screw axis, which is different from 0° and from 90°, for example an angle of between 3.5° and 10°.

In particular, the clamping region can be conical with a cone angle of for example between 7° and 20°.

A concave region can be formed apically of the clamping region. It has been found that the avoidance of inner sockets improves the breakage strength of the ceramic occlusal screw.

An inner socket can also be avoided on the apical side of the screw head by way of the screw shank merging into the screw head via a fillet (i.e. a further concave region).

The stop at the apical side of the screw head, instead of being formed by a shoulder that is perpendicular to the screw axis can be formed by a conical stop region. The cone, which forms the stop region, is then comparatively flat, with a cone angle of more than 90°.

An implant system according to the invention, apart from an occlusal screw of the aforementioned type also includes an anchoring part, for example with an outer thread, with a recess. Herein, the recess coronally forms a receiving region for receiving a fastening post of the abutment as well as apically of this an inner thread for interaction with the screw shank of the occlusal screw. The receiving region coronally can form a conical support region and apically of this an inner structure region with an insert geometry (inner geometry) for the engagement of a rotating-in tool as well as for the interaction with a corresponding rotation lock structure of the abutment.

Furthermore, an abutment with a fastening post, with an opening that is continuous in the axial direction and which is with a stop for the screw head of the occlusal screw, as well as with an occlusal structure (for example a coronal post) for fastening a crown or another tertiary structure also belongs to the implant system. Furthermore, a screwing tool, in particular a tool with the characteristics discussed above can further also belong to the implant system.

The screwing tool supplementarily or alternatively to these characteristics can also include a predetermined breaking location. The torque for breaking the screwing tool at the predetermined breakage location is herein selected such that it is smaller, in particular significantly smaller than the lowest torque, at which a breakage of the occlusal screw is possible.

Herein, the anchoring part as well as the abutment is likewise ceramic. In particular, the anchoring part can be designed as a bone-level anchoring part (sub-gingival implant), i.e. it belongs as a whole to the enossal part of the implant system and is shaped such that it is envisaged to be sunk to the bone crest height, which for example excludes the presence of a coronal (transgingival) region which widens substantially with respect to the thread. However, it can also be designed differently, for example also as a tissue level anchoring part.

Likewise, a subject-matter of the invention is a set of an occlusal screw of the type, which is described in this text, and a screwing tool of the type, which is likewise described in this text. Features of the occlusal screw which are described in this text or defined in the patent claims can relate to the occlusal screw as such as well as to the set as well as to the implant system. This analogously applies to features of the screwing tool which can relate to the set as well as to the implant system.

The ceramic material of the occlusal screw, as well as possibly of the anchoring part and/or of the abutment can be an oxide ceramic, for example ceramic based on zirconium oxide, in particular a yttrium-stabilised ceramic, which is based on zirconium oxide. Ceramics based on aluminium oxide can also be used.

In this text, the terms “coronal” and “apical” are used with respect to the elements of the implant system, as they apply to the implanted state, in which the anchoring part is screwed into the jawbone and the abutment (and possibly the superstructure) is fastened to the anchoring part, analogously to the natural tooth, i.e., “apically” is the direction towards the root tip, into the inside of the jawbone, “coronally” the opposite direction to the tooth crown.

### BRIEF DESCRIPTION OF THE DRAWINGS

The subject-matter of the invention is hereinafter explained in more detail by way of preferred embodiment examples which are represented in the accompanying drawings. What is shown in scales which are partly different from figure to figure are:

FIG. 1 an implant system with an anchoring part, abutment, occlusal screw and screwing tool, in one view,

FIG. 2 a sectioned representation (parallel to the axis, sectioned along the plane A-A) of the system according to FIG. 1;

FIG. 3 a view corresponding to FIG. 1 of the system in the put-together state;

FIG. 4 a sectioned representation (parallel to the axis, sectioned along the plane B-B) of the arrangement according to FIG. 3;

FIG. 5 a representation of the occlusal screw;

FIG. 6 a detail of the occlusal screw;

FIG. 7 a sectioned representation of a suitable screwing tool; and

FIG. 8 a detail of the screwing tool of FIG. 7.

### DETAILED DESCRIPTION OF THE INVENTION

In the figures, the same reference numerals denote the same or analogous parts.

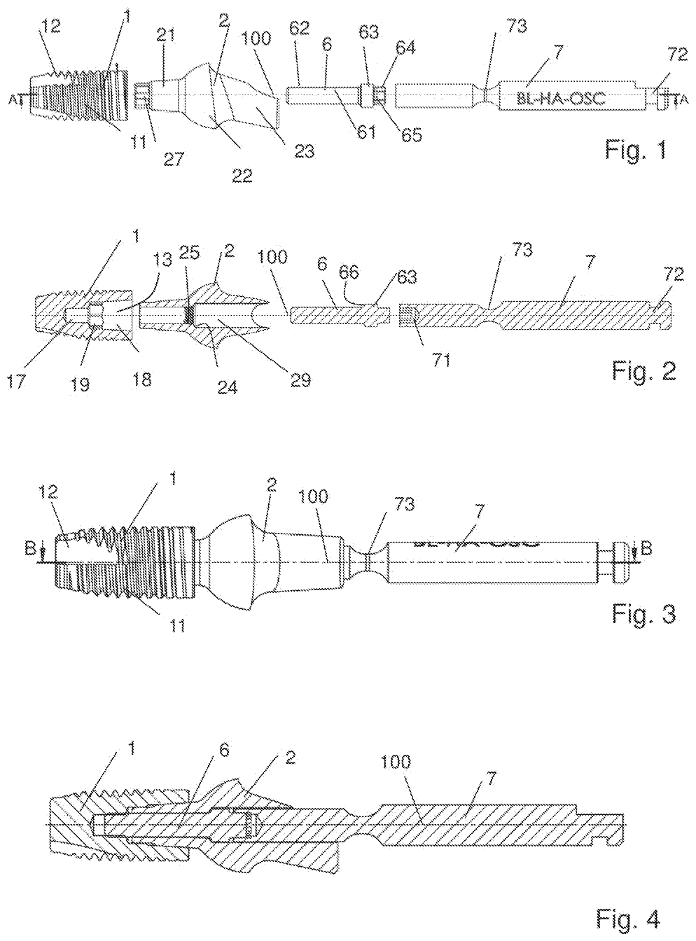

The dental implant (anchoring part 1) which amongst others is represented in FIGS. 1-4, has an outer thread 11 that extends almost over the entire length, almost up to the coronal end and that defines an axis 100. The anchoring part 1 has a shape that tapers slightly in the apical direction, so that in cross section along a plane parallel to the axis 100 as a whole with the exception of the thread furrows and apical chip grooves 12 it is curved in a slightly convex manner and, as a whole, merges from a coronally roughly cylindrical shape into an apically tapering shape. The outer thread 11 has a non-constant thread depth and is designed for example in a self-cutting manner.

A recess 13 into which a fastening post 21 of an abutment 2 projects in the finished implanted state of the implant system is open to the coronal end. The recess forms a coronal support region 18, apically thereof an insert geometry region 19 and apically of this an inner threaded region 17. The support region 18 as a whole has a conical course with a diameter that widens slightly in the coronal direction. The recess forms an insert geometry in the insert geometry region 19 by way of it running about the axis 100 in a manner that is not rotationally symmetrical. In the represented embodiment example, an equilateral hexagon with rounded corners is formed in cross section along a plane perpendicular to the axis 100, wherein it is cylindrical in the sense that it has a constant cross section along the axis. The inner threaded region is provided with an inner thread which is matched to a screw thread of the occlusal screw.

In the represented embodiment example, the anchoring part is a bone-level implant, with regard to which the implant shoulder 10 with a circular edge which terminates the inner connection between the anchoring part 1 and the abutment 2 is at bone level. The invention, however, can also be applied to other two-part implant systems, specifically to tissue level implants, concerning which a transgingival region, which is widened, for example, in a tulip-like manner, is formed on the anchoring part coronally of the enossal part with the thread.

Apart from the fastening post 21, the abutment 2 includes a coronal post 23 for fastening a superstructure. Apically of this there is formed a transgingival region 22, which is adapted, for example, to the expected course of the gingiva. The shapes of such a transgingival region 22 as well as of the post 23—here angled with respect to the axis 100 and drawn with an optional flattening—including its angle to the fastening post and thus to the axis 100 are adapted to specific requirements and depend on where the implant is placed or has been placed in the jaw. In particular, an implantation set with at least one anchoring part can comprise several different abutments for different implant situations.

The fastening post 21 forms a support portion that, in its shape, is matched to the support region 18 and apically of this, a rotation lock structure 27. The rotation lock structure 27 has a hexagonal shape, likewise with rounded edges.

The abutment has an axially continuous opening 29 for the occlusal screw. Furthermore, this opening forms a shoulder 24 for the head of the occlusal screw. Furthermore, in the represented embodiment example an optional abutment inner thread 25 for a so-called retrieval tool (a tool for removing the abutment) is present on the opening.

The occlusal screw 6 has a shank 61 with the outer thread 62 that is matched to the inner thread of the anchoring part, as well as a screw head 65. This head forms an engagement portion 64 and apically of this a widening 63 and furthermore a screw stop 66 in the apical direction. The engagement portion 64 is shaped out as an outer structure for the interaction with a corresponding inner structure of the screwing tool. In the represented embodiment example, the engagement portion has a hexagon structure.

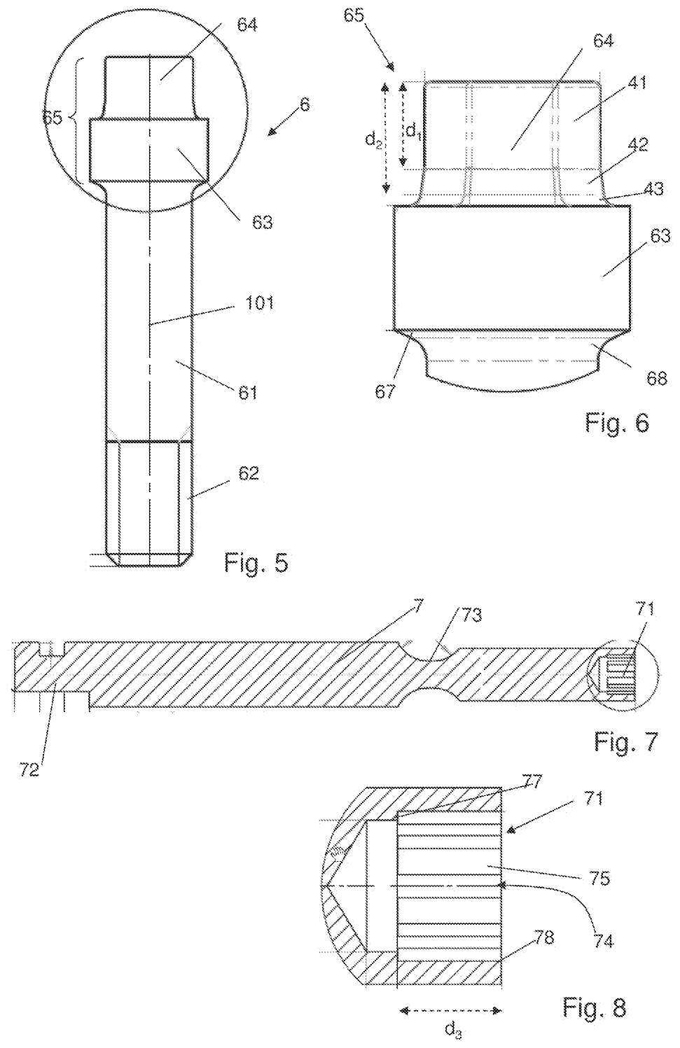

The outer thread 62 of the occlusal screw defines a screw axis 101 (see FIG. 5 hereinafter). In the represented embodiment example, this coincides with the axis 100 of the implant. This per se is not a necessity. Configurations in which the screw axis and accordingly also the axially continuous opening 29 in the abutment as well as the inner threaded region 17 are slightly offset and/or slightly inclined to the axis 100 of the implant are also conceivable.

The screw tool 7 at one end forms an engagement region 71 which is matched to the engagement portion 64. At the opposite (coronal/proximal) end it includes an adapter head 72 for a screw instrument, for example a screw instrument (ratchet) for applying a defined, e.g., settable torque.

A further optional feature of the screwing tool is likewise visible in FIG. 1-4. The screwing tool along its course forms a necking 73, which forms a predetermined breakage location. The torque for breaking the screwing tool at the predetermined breakage location is significantly smaller than the torque for breaking the occlusal screw. For example, the predetermined breakage location is to break at a value between approx. 15-25 Ncm, while the screw breaks at a torque which for example is at least 5 Ncm larger than this value. In particular, the torque for breaking the screw can be at least 20% or at least 30% higher than that of the predetermined breakage location.

The setting of the strength of the predetermined breakage location can be effected, for example, in a very simple manner via the material thickness at the location of the necking and can include an experimental determining of the torque causing a breakage as a function of the cross-sectional area at the location of the lowest material thickness. The maximal torque that can be applied to the occlusal screw can be determined experimentally, too.

FIG. 5 shows the occlusal screw 6 in a view with an outer thread 62, which is merely represented schematically, and FIG. 6 shows the region, which is circled in FIG. 5 in an enlarged and somewhat more detailed manner. It is particularly shown in FIG. 6 than one can see that the engagement portion 64 apart from a cylindrical (i.e. translation-symmetrical along the axis) region 41 includes apically thereof a clamping region 42 that continuously widens in the apical direction. The cylindrical region 41 has an outer hexagonal shape, i.e., it is hexagonal with rounded corners in a cross section perpendicularly to the axis. The clamping region as a rule has the same symmetry as the cylindrical region, i.e., in the present example it is likewise hexagonal in cross section.

In the represented embodiment example, the clamping region, which is subsequent to the cylindrical region 41, is conical, with a cone angle (cone angle/cone opening angle, corresponding to double the angle to the axis) of approx 14°. Generally, in the case of a conical clamping region it is preferable for the cone angle to be between 7° and 20°, in particular between 10° and 18°.

In the represented embodiment example, the clamping region merges via a fillet into a shoulder, which is formed in the coronal direction and which is formed by the widening, i.e., a concave region 43 is formed apically of the clamping region.

A further detail of preferred embodiments can be seen in FIG. 6 at the lower side of the widening 63. The screw stop 66 is not formed by a straight shoulder but rather includes a conical stop region 67 with a large cone angle of above 90°. Subsequent to this apically, the occlusal screw 6 forms a further fillet 68. The shoulder 24 of the continuous opening 29 of the abutment can likewise be formed at a non-right angle to the screw axis in accordance with the conical stop region 67, which can be seen in FIG. 2.

It has been found that the fillet 68 as well as the conicity of the stop region 67 contributes to the breaking strength of the ceramic occlusal screw.

The screwing tool is shown in section in FIG. 7. FIG. 8 shows the region that is circled in FIG. 7 in an enlarged manner. The engagement region is relatively thin-walled with an average (i.e. averaged over the peripheral direction) wall thickness of a mere approx. 0.3 mm. Preferably, the wall thickness is in a range of between 0.18 mm and 0.4 mm, in particular between 0.25 mm and 0.35 mm. The engagement region forms a hexagonal inner structure that is cylindrical, i.e., translationally symmetrical along the screw axis.

The axial extension d₃ of the engagement region 71 (or in order to be more precise of its part region that includes a cylindrical inner structure 75) is larger than the axial extension d₁ of the cylindrical region 41 and, for example, at least equally large as the cumulated axial extension d₂ of the cylindrical region 41 and of the clamping region 42, so that it is not its engagement region 71 or the apical end 77 of its cylindrical part region, but its coronal end which forms a stop when the screwing tool is brought into engagement with the occlusal screw. This is effected by way of the peripheral inner edge 78 abutting at the clamping region 42 at the mouth of the opening 74, said opening being formed by the engagement region 71.

1. An occlusal screw for a ceramic implant system, comprising a screw head and a screw shank, wherein the screw shank comprises a screw thread which defines a screw axis and is envisaged to engage through an opening of an abutment of the implant system which is continuous in the axial direction, into an inner thread in a recess of an anchoring part of the implant system and wherein the screw head apically forms a screw stop, wherein the occlusal screw consists of a ceramic material and comprises an engagement portion which has an outer structure which is not rotationally symmetrical about the screw axis, is cylindrical or conical at least in regions and is suitable for interacting with a corresponding inner structure in a distal recess of a screwing tool, in order to couple the occlusal screw onto the screwing tool in a rotationally fixed manner.

2. The occlusal screw according to claim 1, wherein the engagement portion at least regionally is cylindrical with respect to the screw axis.

3. The occlusal screw according to claim 1, wherein the engagement portion comprises a cylindrical region and apically of this a clamping region which continuously widens in the apical direction.

4. The occlusal screw according to claim 3, wherein the clamping region is conical.

5. The occlusal screw according to claim 4, wherein the clamping region has a cone angle of between 7° and 20°.

6. The occlusal screw according to claim 3, wherein a concave region is formed apically of the clamping region.

7. The occlusal screw according to claim 1, wherein the stop (66) is formed by a conical stop region with a cone angle of more than 90°.

8. The occlusal screw according to claim 7, wherein the conical stop region merges into the screw shank via a fillet.

9. The occlusal screw according to claim 1, wherein the engagement portion comprises the structure of a regular hexagon.

10. A dental implant system comprising:
an anchoring part for anchoring in bone tissue, wherein the anchoring part is manufactured of a ceramic material and defines an axis,
an abutment of a ceramic material,
wherein the anchoring part comprises a recess which is open towards a coronal end, for an engagement of a fastening post of the abutment,
an occlusal screw according to claim 1,
wherein the abutment comprises an opening which is continuous in the axial direction and into which the occlusal screw can be inserted, wherein the occlusal screw is configured, for fastening the abutment to the anchoring part, to engage into an inner thread which is formed on the anchoring part in the recess,
and wherein a shoulder that is formed in the coronal direction is present in the opening, said shoulder together with the screw stop forming a stop on inserting the screw into the opening.

11. The system according to claim 10, wherein the anchoring part comprises an outer thread whose threaded axis corresponds to the axis.

12. The system according to claim 10, wherein the recess forms a conical support region, into which a conical support portion of the abutment engages.

13. The system according to claim 10, wherein the recess comprises an inner structure region with an inner structure which forms an insert geometry for interaction with a corresponding rotation lock structure of the abutment.

14. The system according to claim 12, wherein the recess from coronally to apically firstly forms the support region, then the inner structure region and then an inner threaded region.

15. The system according to claim 10, wherein the anchoring part is designed as a bone-level anchoring part.

16. The system according to claim 10, further comprising a screwing tool with an engagement region which forms an opening with an inner structure which is matched to the outer contour of the engagement portion, in order, given the engagement portion inserted into the opening, to rotate the occlusal screw by way of rotating the screwing tool about the screw axis.

17. A set, comprising an occlusal screw according to claim 1 as well as a screwing tool with an engagement region which forms an opening with an inner structure which is matched to the outer contour of the engagement position, in order, given the engagement portion inserted into the opening, to rotate the occlusal screw by way of rotating the screwing tool about the screw axis.

18. The set according to claim 17, wherein the engagement portion comprises a cylindrical region and apically of this a clamping region which continuously widens in the apical direction, wherein the engagement region comprises a part-region, in which the inner structure is cylindrical, and wherein an axial extension of the part region with the cylindrical inner structure is larger than an axial extension of the cylindrical region.

19. The set according to claim 17, wherein the occlusal screw apically of the engagement portion forms a widening, and wherein an outer diameter in the region of the widening corresponds essentially to an outer diameter of the engagement region of the screwing tool.

20. The set according to claim 17, wherein the screwing tool comprises a predetermined breakage location, at which, when the screwing tool is engaged with the occlusal screw, given the application of an increasing torque on an occlusal end of the screwing tool, the screwing tool breaks without the occlusal screw breaking.

21. The system according to claim 16, wherein the engagement portion comprises a cylindrical region and apically of this a clamping region which continuously widens in the apical direction, wherein the engagement region comprises a part-region, in which the inner structure is cylindrical, and wherein an axial extension of the part region with the cylindrical inner structure is larger than an axial extension of the cylindrical region.

22. The system according to claim 16, wherein the occlusal screw apically of the engagement portion forms a widening, and wherein an outer diameter in the region of the widening corresponds essentially to an outer diameter of the engagement region of the screwing tool.

23. The system according to claim 16, wherein the screwing tool comprises a predetermined breakage location, at which, when the screwing tool is engaged with the occlusal screw, given the application of an increasing torque on an occlusal end of the screwing tool, the screwing tool breaks without the occlusal screw breaking.
